(19) United States
(12) Patent Application Publication
(10) Pub. No.: US 2005/0225104 A1
(43) Pub. Date: Oct. 13, 2005

(54) System for handling containers

(75) Inventors: Eng Guan Lim, Singapore (SG); Robert Arthur Mills, Lancashire (GB)

Correspondence Address: WOOD, HERRON & EVANS, LLP, 2700 CAREW TOWER, 441 VINE STREET, CINCINNATI, OH, 45202, US

(73) Assignee: NatSteel Engineering PTE LTD., Singapore (SG)

(21) Appl. No.: 10/513,938

(22) PCT Filed: May 10, 2002
(86) PCT No.: PCT/SG02/00085

§ 371 Date: May 16, 2005

(51) Int. Cl. B66C 1/00

(52) U.S. Cl. 294/81.1

(57) ABSTRACT

A system (1) for handling containers, the system (1) comprising: a) a mounting frame (3); b) a rotation device (4) attached to the mounting frame (3); c) a spreader 5 having a main axis and being supported by the rotation device (4), the rotation device (4) being operative to rotate the spreader (5) relative to the mounting frame (3); and d) two extension devices (30, 31), each extension device (30, 31) having a longitudinal axis and adapted for connection to a container (2) a having a length direction parallel to the longitudinal axis; the spreader (5) including inner pickup elements (9a, 9b, 10a, 10b) and outer pickup elements (33a, 33b, 34a, 34b) for releasably connecting the spreader to the extension devices (30, 31) with the extension devices (30, 31) side-by-side and the main axis of the spreader (5) transverse to the longitudinal axis of both the extension devices (30, 31).

### BACKGROUND AND FIELD OF THE INVENTION

This invention relates to a system for handling containers, more particularly but not exclusively, for handling two containers simultaneously.

Systems for handling goods or freight containers generally comprise a metal frame (commonly known as a “spreader”) attached to a hoist. The spreader is lowered by the hoist onto the top surface of the container and engages the container at each of its four corners. Conventional spreaders generally only lift a single container. The spreader engages with the container at each of the four corners using pickup elements known as twistlocks. Each twistlock locates in a hole on each corner of the container. After being located in the holes, the twistlocks are rotated to lock the container to be lifted to the spreader. The spreader can then be lifted by the hoist with the container attached. This enables the container to be transferred from one location to another location, such as between a dock and a ship or between ground locations, such as from a storage position to a ground transportation vehicle. When the containers are appropriately positioned, the twistlocks disengages from the respective holes in the container and the system is free for the next handling operation.

To enhance the functionality of the system, a rotation device, commonly known as a rotator, may be arranged to rotate the spreader during the lifting operation. This allows the container to be orientated to a suitable position before placing the container onto its designated location. In addition, the rotator is typically equipped with means to adjust the position of the rotator with respect to the container being lifted. This allows the system to adjust the centre of gravity of the lifting operation especially for a container with uneven loads.

In recent years twinlift spreaders have been developed which are capable of handling two 20 feet containers in end-to-end relationship simultaneously. One such spreader is described in an international patent application no. WO 01/62657 by the present applicant. Such a spreader, however, can only manage two 20 feet containers simultaneously or a single 40 or 45 feet container at any one time, depending on the configuration and length of the spreader extensions, but is not adapted for lifting two 40 feet containers simultaneously. Further, due to the engineering complexity considerations, such spreaders are not fitted with a rotation device, and thus are intended for lifting containers having a single orientation.

There has also been proposed a system using two fixed length spreaders for lifting two 40 feet containers simultaneously and in parallel but this system is only adapted for lifting containers similar to its fix frame length, and it cannot lift containers less than or more than its fix frame length without replacing the spreaders. Therefore, during a lifting operation where there are different sizes of containers in a consignment, the spreaders will have to be replaced to the appropriate type, which can be a tedious and time-consuming process.

It is an object of the invention to provide a system for handling containers which alleviates at least one of these disadvantages.

### SUMMARY OF THE INVENTION

In a first aspect of the invention, there is provided a system for handling containers each having a length direction and being of differing lengths in that direction, the system comprising:
a mounting frame;
a spreader having a main axis and supported from the mounting frame; and
two extension devices, each extension device having a longitudinal axis and adapted for connection to a container having a length direction parallel to the longitudinal axis;
the spreader including connection means for releasably connecting the spreader selectively to at least one container with the length direction of the container parallel to the main axis of the spreader, or to the extension devices with the extension devices side-by-side and the main axis of the spreader transverse to the longitudinal axis of both the extension devices.

An advantage of the invention is that the system can be adapted to handle two containers simultaneously using the two extension devices without replacing the spreader.

Typically the connection means includes, in order along the main axis of the spreader, a first pair of pickup elements, a second pair of pickup elements, a third pair of pickup elements and a fourth pair of pickup elements, each pair of pickup elements being arranged on respective sides of the main axis of the spreader, whereby the spreader is selectively and releasably connectable:
(i) to a single container by means of two said pairs of pickup elements,
(ii) to a first container by means of the first and second pairs of pickup elements and to a second container by means of the third and fourth pairs of pickup elements, and
(iii) to a first of the extension devices by means of the first and second pairs of pickup elements and to a second of the extension devices by means of the third and fourth pairs of pickup elements.

Preferably, the first and fourth pairs of pickup elements are relatively movable along the main axis; the first and second pairs of pickup elements are relatively movable along the main axis; and the third and fourth pairs of pickup elements are relatively movable along the main axis; whereby the spreader is connectable to containers of differing lengths by means of the first and fourth pairs of pickup elements, by means of the first and second pairs of pickup elements, or by means of the third and fourth pairs of pickup elements. Normally, for single container operation, the first and fourth pairs of pickup elements are used whereas for twin lift operation, the first and second, and third and fourth pairs of pickup elements are used.

In addition, the first and second pairs of pickup elements are also movable together along the main axis relatively to the third and fourth pairs of pickup elements, whereby when the first and second pairs of pickup elements are connected to a first container, and the third and fourth pairs of elements are connected to a second container, the spacing of the first and second containers may be varied.

Preferably, to vary the spacing between the two containers, the spreader includes two first extendable members movable parallel to the main axis of the spreader between a first position in which the first extendable members are not extended and a second position in which the first extendable members are extended, and two second extendable members, each second extendable member being mounted on a respective one of the first extendable members and movable along the respective first extendable member parallel to the main axis between a first position in which the second extendable member is not extended from the respective first extendable member and a second position in which the second extendable member is extended from the respective first extendable member, the first pair of pickup elements being connected to a first of the second extendable members, the second pair of pickup elements being connected to the corresponding one of the first extendable members, the third pair of pickup elements being connected to the other of the first extendable members, and the fourth pair of pickup elements being connected to the other of the second extendable members.

Preferably, the second pair of pickup elements is in a fixed position relative the corresponding one of the first extendable members in the direction parallel to the main axis of the spreader, the third pair of pickup elements is in a fixed position relative to the other of the first extendable members in the direction parallel to the main axis of the spreader.

Alternatively, the second pair of pickup elements may be movable relative to the corresponding one of the first extendable members in the direction parallel to the main axis of the spreader, the third pair of pickup elements is movable relative to the other of the first extendable members in the direction parallel to the main axis of the spreader, whereby the spacing between the first and second pickup elements, and between the third and fourth pickup elements, can be varied independently of the extension of the second extendable members relative to the first extendable members.

Typically, the system further comprises a rotation device attached to the mounting frame and supporting the spreader, the rotation device being operative to rotate the spreader relative to the mounting frame.

In this case, preferably, the spreader includes one or more guide rails, and the rotation device is connected to the guide rails slidably thereupon. The movement of the rotation device on the guide rails provides centre of gravity adjustment, as is particularly useful when the main axis of the mounting frame is in an orientation in which the extension of the mounting frame is relatively small, since it is highly desirable that the centre of gravity of the system and containers remains directly under the horizontal area defined by the mounting frame.

### BRIEF DESCRIPTION OF THE DRAWINGS

Embodiments of the invention will now be described, by way of example, with reference to the accompanying drawings, in which:—

FIG. 1 is a perspective view of a first embodiment of the invention which illustrates a system for handling containers which comprises a spreader arranged to lift a 20 feet container;

FIG. 2 illustrates the system of FIG. 1 arranged to lift two 20 feet container simultaneously;

FIG. 3 illustrates the system of FIG. 2 wherein the two 20 feet containers are spread longitudinally;

FIG. 4 illustrates the system of FIG. 1 arranged to lift a 40 feet container;

FIG. 5 illustrates the system of FIG. 1 wherein two extension devices are attached to the spreader for lifting two 40 feet containers simultaneously;

FIG. 6 illustrates the system of FIG. 5 wherein the two 40 feet containers are spread laterally;

FIG. 7 is a perspective view of a second embodiment of the invention which illustrates a system for handling containers which comprises a spreader adapted to achieve a zero gap between containers in the lateral direction transversely to the axis of the mounting frame;

FIG. 8 is a side view of the system of FIG. 7;

FIG. 9 illustrates the system of FIG. 7 arranged to lift a 20 feet container;

FIG. 10 illustrates the system of FIG. 7 arranged to lift a 40 feet container;

FIG. 11 illustrates the system of FIG. 7 arranged to lift two 20 feet containers in an end-to-end relationship;

FIG. 12 illustrates the system of FIG. 11 wherein the two 20 feet containers are spread longitudinally;

FIG. 13 illustrates the system of FIG. 7 wherein two extension devices are attached to the spreader for lifting two 40 feet containers simultaneously; and

FIG. 14 illustrates the system of FIG. 13 wherein the lateral distance between the two 40 feet containers is adjusted to achieve a zero gap.

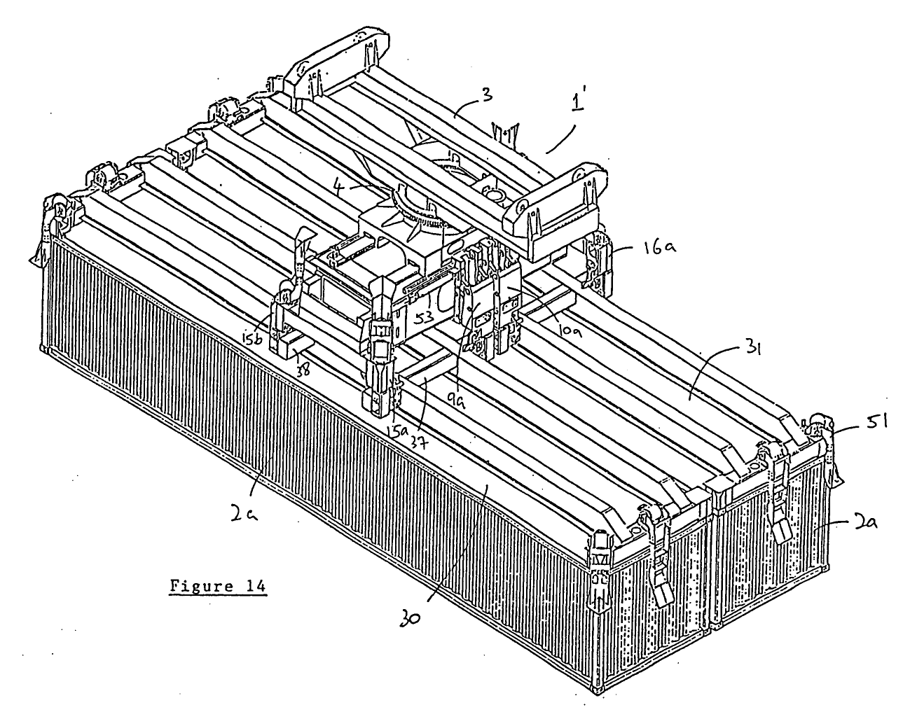

### DETAILED DESCRIPTION OF THE PREFERRED EMBODIMENTS

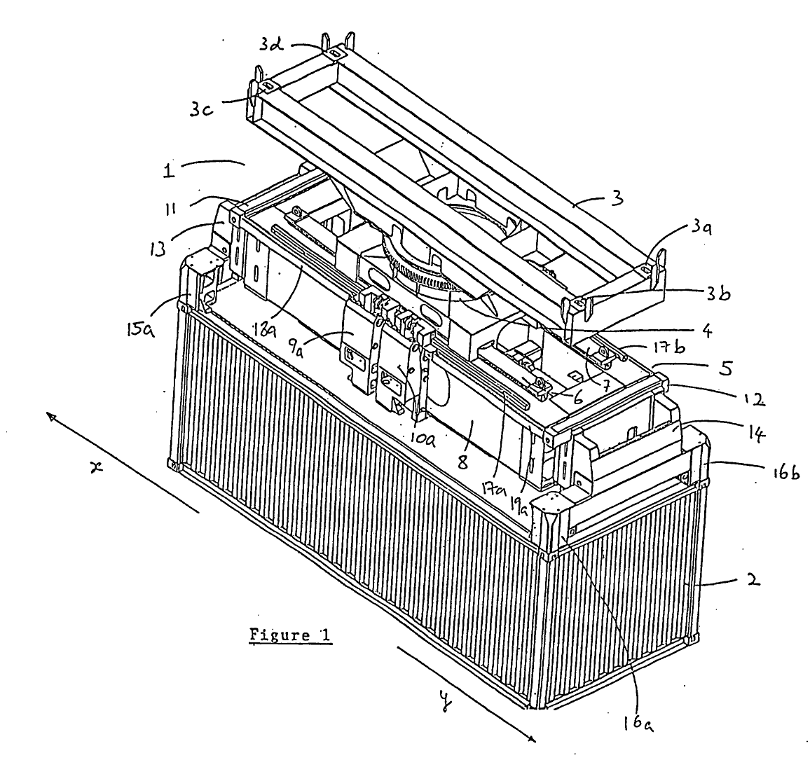

A first embodiment of the invention is shown in FIG. 1, which illustrates a system 1 for handling containers. The system 1 is arranged to lift a 20 feet by 8 feet container 2 and comprises a mounting frame 3, a rotation device 4 attached to the mounting frame 3 and a spreader 5 supported by the rotation device 4.

Typically, the mounting frame 3 is of a rectangular shape and comprises four lifting holes 3a,3b,3c,3d, each hole disposed at one of the four corners of the frame 3 to allow hoisting of the system 1 by a crane (not shown) using cables secured to the lifting holes 3a,3b,3c,3d.

The rotation device 4 is arranged to rotate the spreader 5 with respect to the mounting frame 3. The rotation device 4 is also slidably connected on two parallel guide rails 6,7 which provide an off-eccentric adjustment when the rotation device 4 is moved along these guide rails 6,7. The movement adjusts the centre of gravity of the lifting operation to stabilise the system 1 when lifting and/or transferring the container 2 especially if the load is uneven. This is also particularly important when handling two containers 2 simultaneously.

A conventional spreader 5 can be used and in this embodiment, the spreader 5 is similar to that described in the international (PCT) patent application No. WO 01/62657 by the present applicant, the contents of which is incorporated herein by reference.

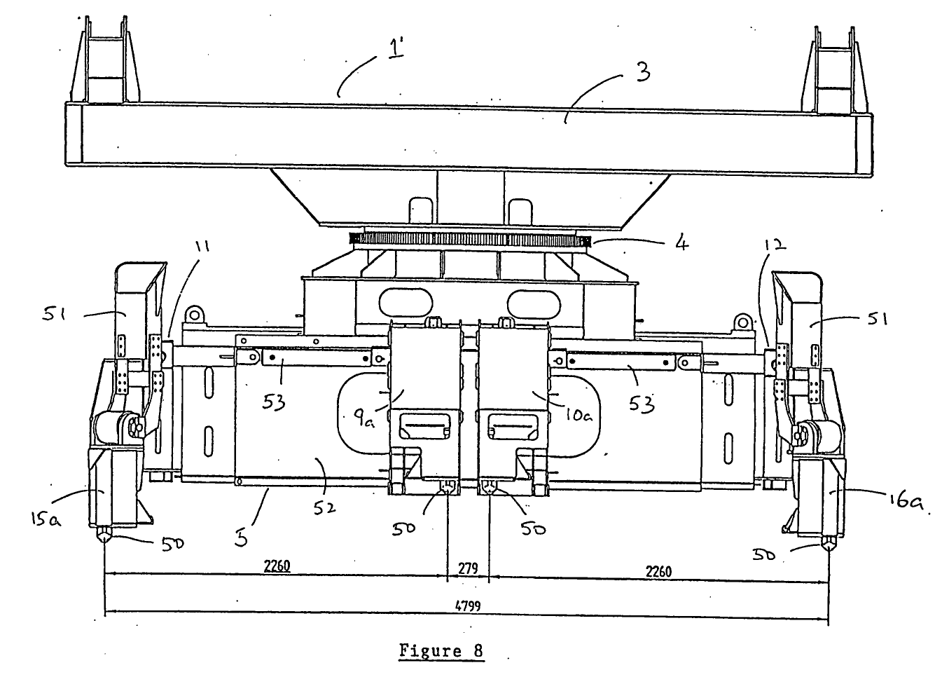

The spreader 5 comprises a body member 8, first extendable members 11,12, second extendable members 13,14 and connection means for releasably connecting the spreader 5 selectively to at least one container and in this embodiment, the connection means is in the form of four inner pickup elements 9a,9b,10a,10b and four outer pickup elements 15a,15b,16a,16b. Each pickup element 9a,9b,10a,10b,15a,15b,16a,16b includes a twistlock element 50 (see FIG. 8) which can be engaged with an aperture located at each corner of the container 2 to be lifted. The twistlock element 50 is rotated or “twisted” to lock or unlock the container 2 to the respective pickup elements 9a,9b,10a,10b, 15a,15b,16a,16b. Note that the twistlock elements 50 may in alternative embodiments be replaced by any other suitable connector device, such as pins or hooks.

The inner pickup elements 9b,10b are not shown in the drawings and neither is the outer pickup element 15b. In the context of this application, the letters “a” and “b” when added to the same reference numeral will be used to represent two identical components performing the same function.

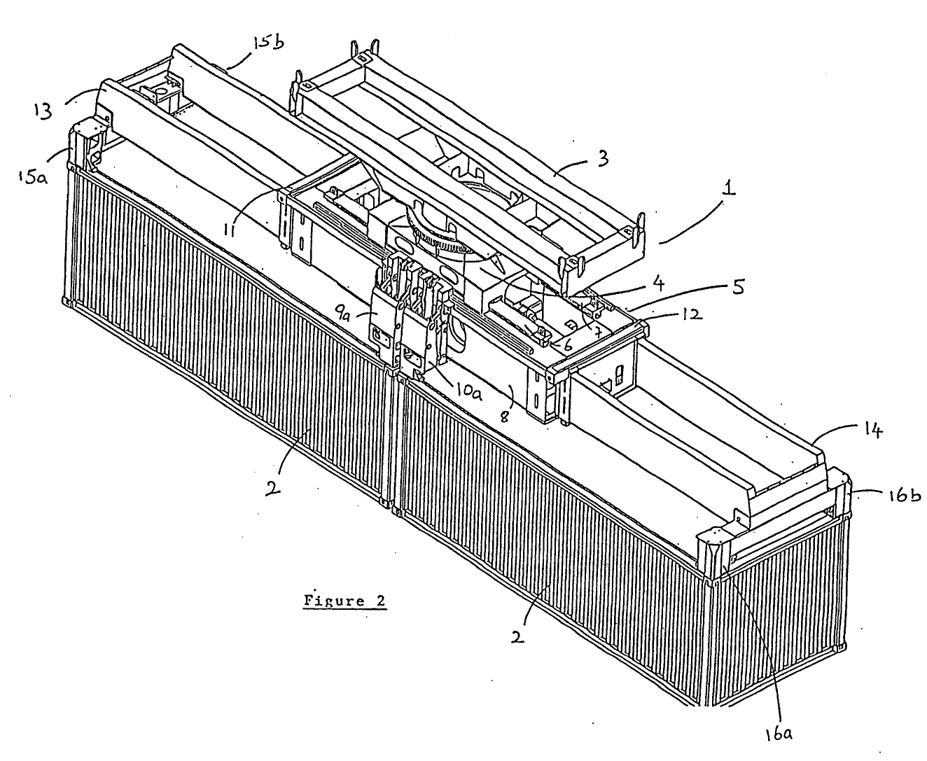

The inner pickup elements 9a,10a are movably mounted on a rail 17a on one to side of the body member 8 whereas the other inner pickup elements 9b,10b (not shown) are movably mounted on rail 17b on the other side thereof. In addition, the first pair of inner pickup elements 9a,9b are connected to the first extendable member 11 by link rods 18a,18b (18b not shown) respectively and the second pair of inner pickup elements 10a,10b are connected to the other first extendable member 12 by link rods 19a,19b (19b not shown) respectively. In this way, extending the first extendable member 11 moves the pair of inner pick-up elements 9a,9b along the rails 18a,18b in the direction as indicated by arrow x in FIG. 1. Similarly, extending the other first extendable member 12 moves the other pair of inner pickup elements 10a,10b but in the opposite direction, as indicated by arrow y in FIG. 1. In addition, the inner pickup elements 9a,9b,10a,10b can be moved between a lowered position and a raised position as shown in FIGS. 1 and 2, which depict the two positions between which the pickup elements 9a,10a can be moved.

Two of the outer pick-up elements 15a,15b are mounted at one end of one of the second extendable member 13 and the other two pickup elements 16a,16b are mounted on the other second extendable member 14. Each of the outer pickup elements 15a,15b,16a,16b further includes a locating device 51 (see FIG. 8) which locates a corner of the container 2 to aid the pickup elements 15a,15b,16a,16b in engaging with the respective apertures on top of the container 2.

The extension and retraction of the first and second extendable members 11,12,13,14 is via a chain drive and piston mechanism controlled by an operator of the system 1 similar to that described in the international (PCT) patent application No. WO 01/62657 by the present applicant. Therefore, the detailed operation of how the chain drive and piston mechanism work in combination to extend or retract the first and second extendable members 11,12,13,14 will not be described here.

As shown in FIG. 1, the inner pickup elements 9a,9b,10a,10b are not used and are in a resting position whereas the outer pickup elements 15a,15b,16a,16b are used to engaged the 20 feet container 2 for lifting, transferring and/or lowering between two locations. The length of the spreader 5 with the first and second extendable members 11,12,13,14 fully retracted is approximately 20 feet which corresponds to the length of the 20 feet container 2. Therefore, when handling the 20 feet container 2, the first and second extendable members 11,12,13,14 do not need any adjustment to align the outer pickup elements 15a,15b,16a,16b to the four corners of the container 2.

The rotation device 4 may be used to rotate the spreader 5 with respect to the mounting frame 3 so as to orientate the container 2 in a particular direction for placement, for example, onto a trailer. During the rotation of the spreader 5, the rotation device 4 may move along the guide rails 6,7 to adjust the centre of gravity of the system 1 to balance the uneven load in the container 2.

When the system 1 is used to pickup two 20 feet containers 2, the inner pickup elements 9a,9b,10a,10b are lowered as shown in FIG. 2. The second extendable members 13,14 are next extended to a predetermined length required to pickup the containers 2. Each adjacent pair of outer pickup elements 15a,15b and 16a,16b work in conjunction with each corresponding pair of inner pickup elements 9a,9b and 10a,10b to lift the two 20 feet containers 2. In this arrangement, the two containers 2 can be supported with a zero gap between them, as illustrated in FIG. 2. Again, the rotation device 4 may be used to orientate the containers 2 or the position of the rotation device 4 adjusted with respect to the containers 2 to change the centre of gravity of the system 1 during the lifting or transferring process.

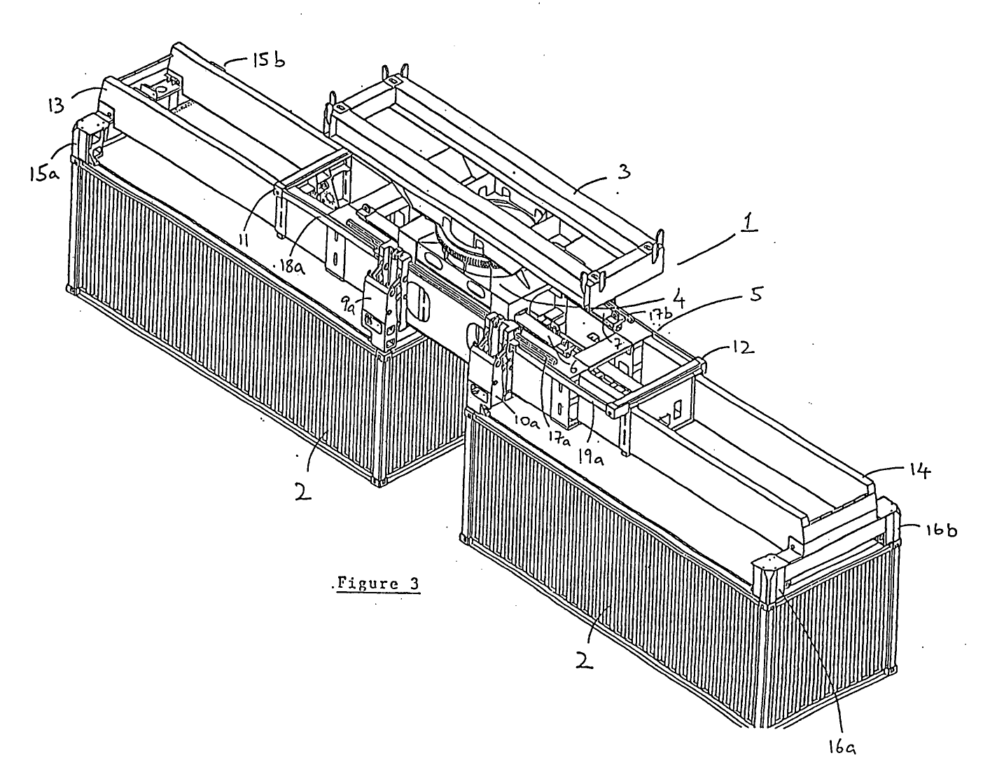

To spread the two containers 2 longitudinally, the first extendable members 11,12 are extended, as shown in FIG. 3. As described earlier, the inner pickup elements 9a,9b,10a,10b are fixedly coupled by link rods 18a,19a,18b,19b to their respective first extendable members 11,12 so that the extension of the first extendable members 11,12 move the respective inner pickup elements 9a,9b,10a,10b in opposite directions along the rails 17a,17b thereby spreading the two containers 2. The maximum spreading distance between the two ends of the two containers 2 is typically 1.6 metres.

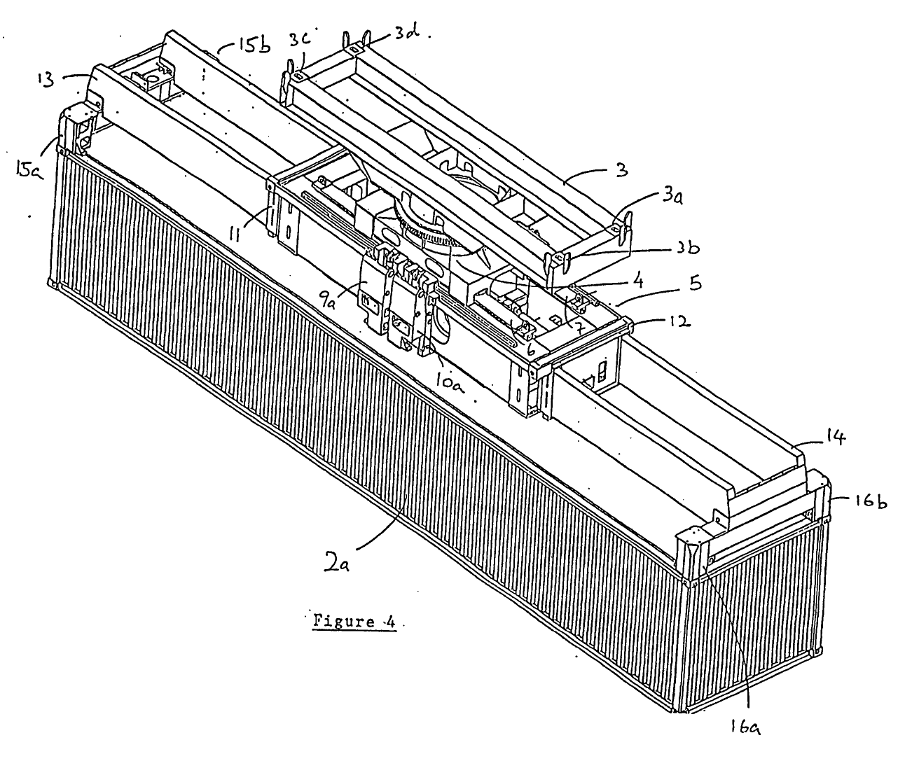

FIG. 4 illustrates the system 1 arranged to lift a single 40 feet container 2a. In this case, the inner pickup elements 9a,9b,10a,10b are retracted and the first extendable members 11,12 withdrawn. The second extendable members 13,14 of the spreader 5 are extended to a predetermined length for securing the container 2a using the outer pickup elements 15a,15b,16a,16b. If the container 2a is longer than 40 feet, for example a 45 feet container, the lifting operation can be accomplished by also extending one or both of the first extendable members 11,12.

However, as mentioned earlier, the spreader 5 is limited to handling a single 40 or 45 feet container 2a and if simultaneous lifting of two containers of such lengths is desired, then the spreader 5 needs to be replaced to carry out the “twinlift” operation. The replacement of the spreader 5 is time-consuming as the cables of the crane need to be unsecured manually from the lifting holes 3a,3b,3c,3d and re-attached to a mounting frame supporting a new spreader or spreaders that could carry out the twinlift operation for 40 feet containers.

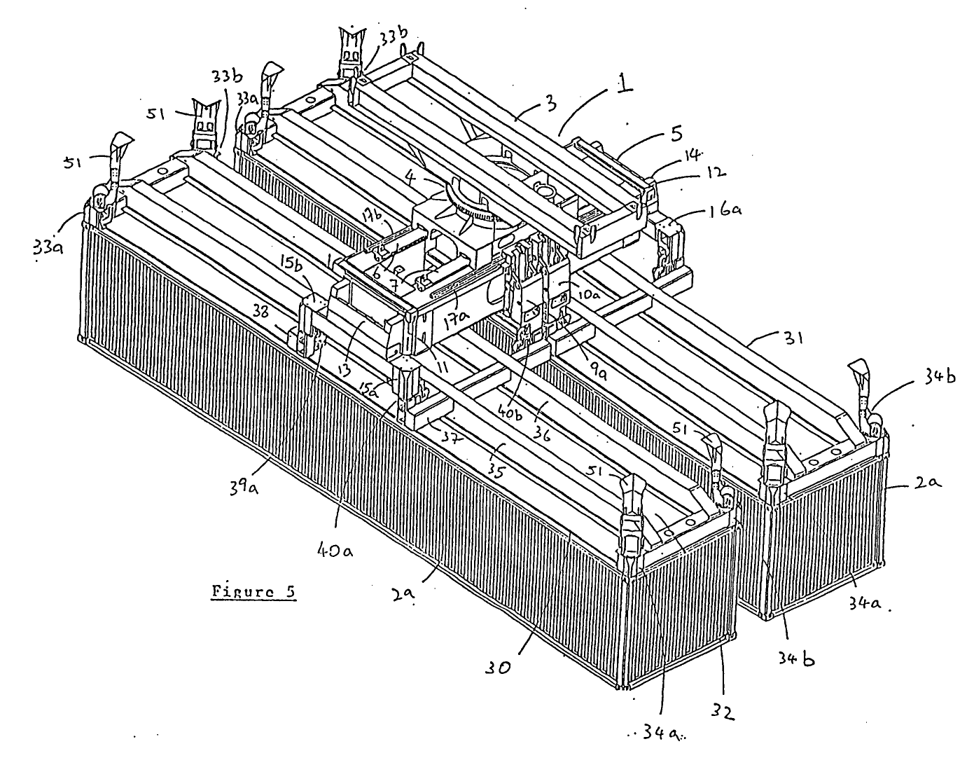

To overcome this limitation, the system 1 further comprises two extension devices 30,31 as shown in FIG. 5. As both extension devices 30,31 are identical, only one extension device 30 will be described with reference to inner pickup elements 9a;9b and outer pickup elements 15a,15b.

The extension device 30 comprises a body member 32 and four outer pickup elements 33a,33b,34a,34b (which may be twistlocks, but may alternatively be any other suitable connector device, such as pins or hooks). The body member 32 is typically 40 feet in length and 8 feet wide to correspond to the dimensions of a typical 40 feet container 2a. The four outer pickup elements 33a,33b,34a,34b are arranged at each corner of the body member 32 to pickup the container 2a. Each outer pickup element 33a,33b,34a,34b also includes a locating device 51 which is similar to that mounted on the outer pickup elements 15a,15b,16a,16b of the spreader 5. Each locating device 51 complements a corresponding outer pick-up element 33a,33b,34a,34b during a pickup operation by locating the four corners of the container 2a so that the pickup elements 33a,33b,34a,34b can engage the corresponding apertures of the container 2a. When the pickup elements 33a,33b,34a,34b are engaged with the apertures, the locating devices 51 may be “flipped” upwards, as shown in FIG. 5, so as not to interfere with the lifting operation.

The extension device 30 also comprises two elevated beams 35,36 running parallel to a longitudinal axis of the extension device 30. Two support bars 37,38 intersect the elevated beams 35,36 perpendicularly near the centre of the body member 8. The extension device 30 further comprises four apertures 39a,39b,40a,40b located at each end of the support bars 37,38 for engaging with pickup elements 9a,9b,15a,15b of the spreader 5.

In this embodiment, the support bars 37,38 and the apertures 39a,39b,40a,40b are arranged so that the corresponding pick-up elements 9a,9b,15a,15b engage with the apertures 39a,39b,40a,40b without a need to extend the first extendable members 11 to adjust the relative positions of the inner pick-up elements 9a,9b. Alternatively, if the support bars 37,38 and the apertures 39a,39b,40a,40b are not so arranged, the first extendable members 11 can be adjusted to move the inner pickup elements 9a,9b so that all the pickup elements 9a,9b,15a,15b are aligned to the apertures 39a,39b,40a,40b. The reason for the adjustment will be now described.

To pickup the extension devices 30,31, the rotation device 4 rotates the spreader 5 with respect to the mounting frame 3 to a position such that a main axis of the spreader 5 transverse to the longitudinal axis of the extension devices 30,31. The length of the spreader 5 is essentially 20 feet as explained earlier. The width of each extension devices 30,31 is 8 feet to correspond to the width of a 40 feet container 2a, so there is a gap of 4 feet between the two containers 2a as shown in FIG. 5. This gap cannot be reduced further due to the construction of the body member 8 and the inner pickup elements 9a,9b,10a,10b. Therefore, to engage the extension devices, the apertures and the support bars 37,38 are arranged to extend beyond the width of the extension devices 30,31 as shown in FIG. 5, so that the inner and outer pickup elements 9a,9b,10a,10b,15a,15b.16a,16b are aligned to the respective apertures 39a,39b,40a,40b of each extension device 30,31 without further adjustment. Alternatively, if the support bars are not so arranged, adjustment of the inner pickup elements 9a,9b,10a,10b is required for the alignment.

When the pick-up elements 9a,9b,10a,10b,15a,15b,16a,16b are aligned to the corresponding apertures 39a,39b,40a,40b, the inner pickup elements 9a,9b,10a,10b of the spreader 5 are next lowered from their resting position. Each set of inner and outer pickup elements 9a,9b,15a,15b and 10a,10b,16a,16b then engages the corresponding apertures 39a,39b,40a,40b of each extension device 30,31 by a twisting action of the twistlock elements 50. When locked, the system 1 picks up the two extension devices 30,31 which in turn are used to lift two 40 feet containers 2a by utilising the pickup elements 33a,33b,34a,34b of the two extension devices 30,31.

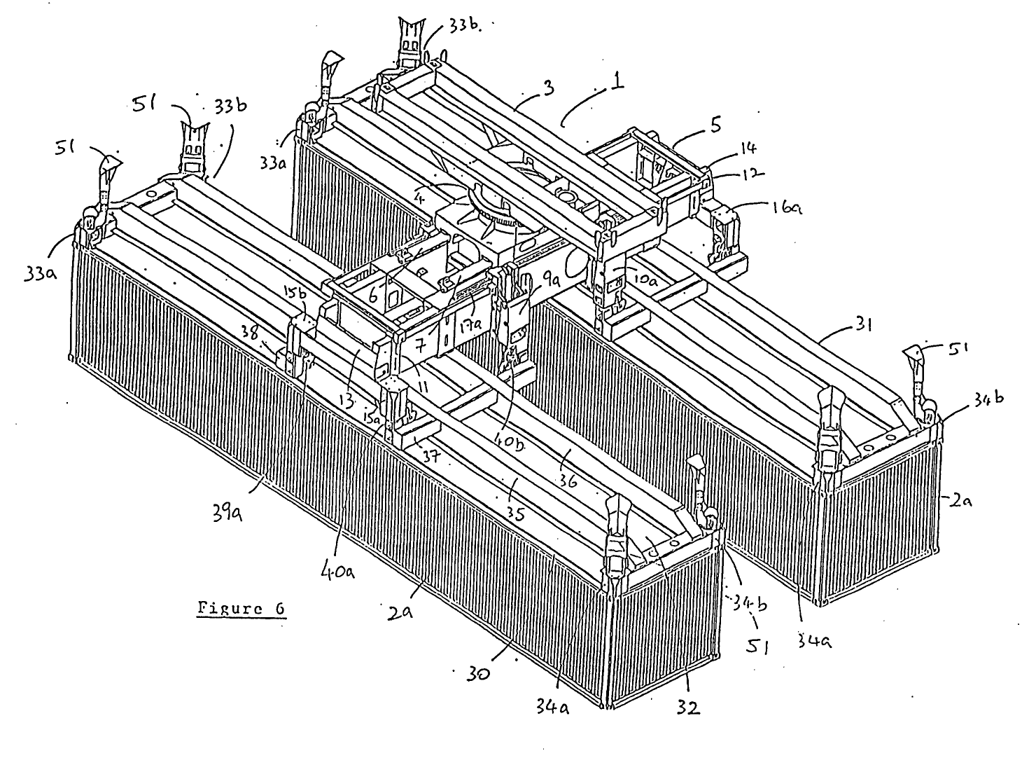

To spread the two 40 feet containers 2a further apart, the first extendable members 11,12 are extended in a way similar to spreading the two 20 feet containers 2 longitudinally, as described above in relation to FIG. 3. However, in this case, the containers 2a are spread laterally, as shown in FIG. 6, since the longitudinal axis of the containers 2a (and also the extension devices 30,31) is substantially perpendicular to the axis of movement of the inner pickup elements 9a,9b,10a,10b. Alternatively, the spreading can be accomplishing by extending the second extendable members 13,14. Typically, this spreading distance is limited to 1.6 metres. As explained earlier, the minimum spreading distance, in this embodiment, would be limited to a gap of approximately 4 feet between the two containers 2a.

The ability to adjust the spreading distance is advantageous as the distance between the two containers 2a to be lifted does not need to match the original distance between the two extension devices 30,31. In addition, this allows two trailers to be conveniently parked side by side to receive the two containers 2a.

As mentioned earlier, the centre of gravity adjustment is particularly important when handling two containers, especially when two 40 feet containers 2a are lifted simultaneously side by side. To compensate for an uneven load, which is common especially in a twinlift operation, the rotation device 4 slides along the guide rails 6,7 to adjust the centre of gravity of the system 1 to stabilise the handling operation. Note that the rotational device 4 remains in a fixed relationship to the mounting frame 3 as the position of the rotation device 4 is adjusted along the guide rails 6,7. The positional adjustment of the rotation device 4 may be carried out remotely by the operator of the crane, or automatically using sensors to detect the imbalance condition and the position of the rotation device 4 is then adjusted accordingly.

The locking or unlocking of the pickup elements 33a,33b,34a,34b on the container 2a and the operation of the locating devices 51 can be activated respectively by the same control for the outer/inner pickup elements 9a,9b,10a,10b,15a,15b,16a,16b and locating devices 51 on the spreader 5. Alternatively, the extension devices 30,31 can be fitted with hydraulic and/or electrical means to activate the pickup elements 33a,33b,34a,34b and/or locating devices 51 for engaging the two 40 feet containers 2a. The hydraulic/electrical means may tap the required power source from the system 1 during the preparation stage when the spreader 5 picks up the two extension devices 30,31.

In use, when the system 1 is lifting 20 feet containers 2, the extension members 30,31 are typically not retrofitted and are kept in a storage location, which may typically be on a trailer. Similarly, if the handling operation requires only lifting of a single 40 feet container 2a at a time, there is no need to use the extension devices 30,31. When twinlift of two 40 feet containers 2a is required to increase the handling efficiency, the trailer transports the trailer to a location such that the crane can move the system 1 above the trailer. The crane then lowers the spreader 5. The inner pickup elements 9a,9b,10a,10b are also lowered from their resting positions. The rotation device 4 then rotates the spreader 5 to the position as described earlier so that the inner 9a,9b,10a,10b and outer pickup elements 15a,16a,15b,16b are able to engage the corresponding apertures 39a,39b,40a,40b of the extension devices 30,31. Subsequently, the two extension devices 30,31 are used for lifting two 40 feet containers 2a simultaneously.

When the lifting operation is completed, the crane moves the system 1 to a position above the trailer and the spreader 5 unlocks and releases the extension devices 30,31. The rotation device 4 then rotates the spreader 5 back to its original position such that the spreader 5 can again be used for lifting a single 20 feet container 2, two 20 feet containers 2 or a single 40 feet container 2a.

The advantage of the invention is that the system 1 can be adapted to handle two 40 feet containers 2a simultaneously using the two extension members 30,31 or attachments, without a need to change the spreader 5. The ability to spread the extension devices 30,31 relative to each other also has a further advantage of engaging two containers side-by-side which do not need to be placed in a fixed distance from each other.

In a second and preferred embodiment of the invention, means are provided in system 1 so that the minimum spreading distance can be adjusted from 4 feet gap to a zero gap between the two containers 2a when the extension devices 30,31 are used to lift both containers 2a side-by-side simultaneously.

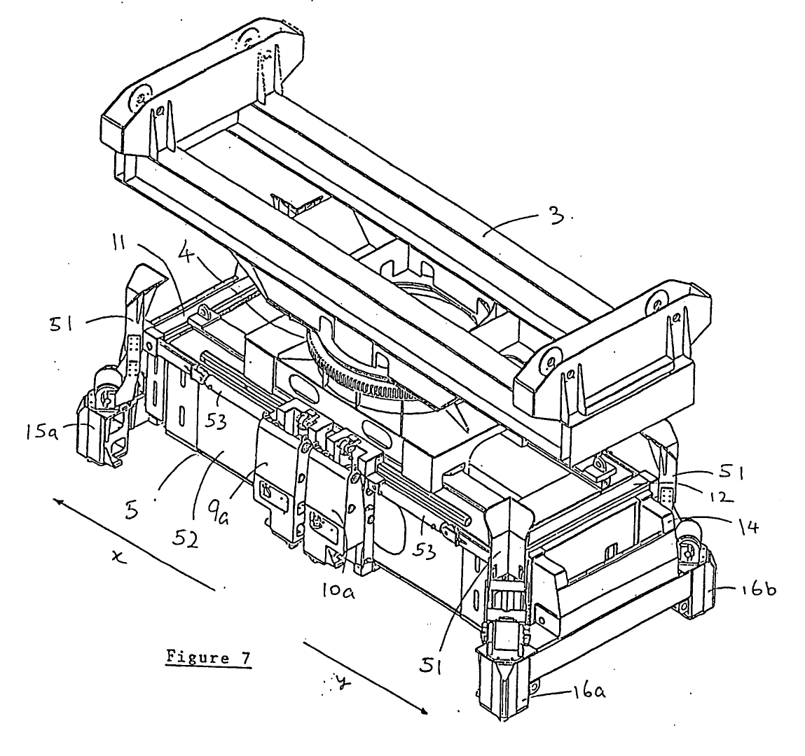

FIG. 7 illustrates a system 1′ according to the second embodiment of the invention which is made up of devices similar to those in the first embodiment except for a modified body member 52 and how the inner pickup elements 9a,9b,10a,10b are connected to the first extendable members 11,12. As such the same reference numerals used to describe the first embodiment are used to represent the corresponding devices in the second embodiment. The body member 52 is shorter as compared with the body member 8 in the first embodiment and in this example, the overall length of the spreader 5 is approximately 16 feet (4799 mm) when the first and second extendable members 11,12,13,14 are retracted fully. This is illustrated with a side view of the system 1′ in FIG. 8.

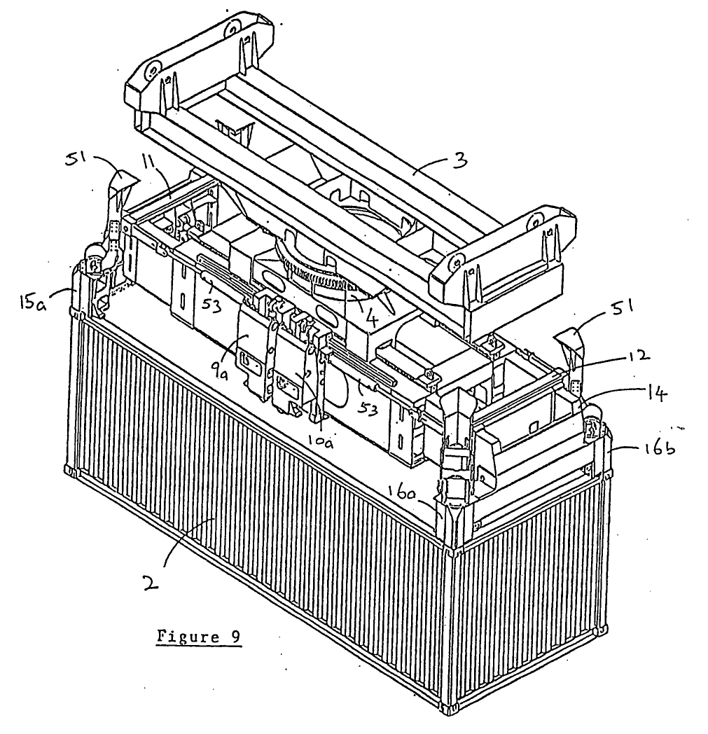

Instead of link rods 18a,18b,19a,19b in the first embodiment, four pistons 53 are used to connect the inner pickup elements 9a,10a,9b,10b to the first extendable members 11,12. Each pair of pistons 53 is arranged to extend from a first position to a second position to move the first extendable members 11,12 along the same axis. In this example, the maximum extendable distance of each piston 53 may be limited to 2 feet in the x and y directions (as shown in FIG. 7). When the pistons 53 are fully extended, the spreader 5 now has an overall length of 20 feet for picking up a typical 20 feet container 2. The partial extension of the extendable members 11,12 initiated by the pistons 53 does not move the inner pickup elements 9a,9b,10a,10b. This is illustrated in FIG. 9, which depicts the action of the pistons 53 to extend the first extendable members 11,12 to form a 20 feet spreader 5 to pickup the 20 feet container 2. Also, when the pistons 53 are fully extended, subsequent extension by the first extendable members 11,12 will move the corresponding inner pickup elements 9a,9b,10a,10b. Therefore, when fully extended, the pistons 53 are similar to the link rods 18a,18b,19a,19b in the first embodiment.

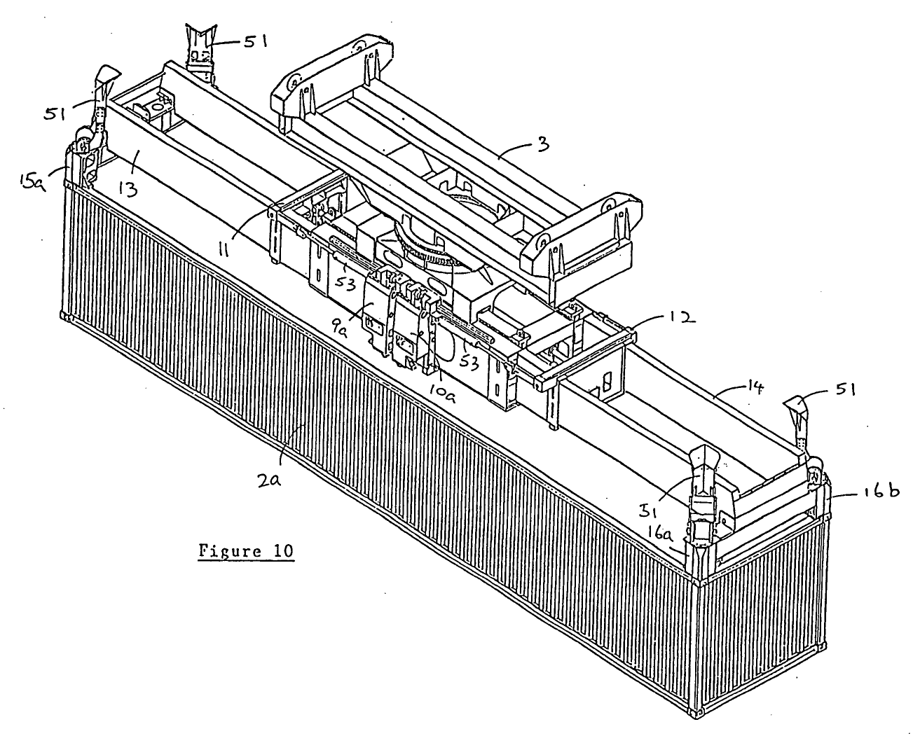

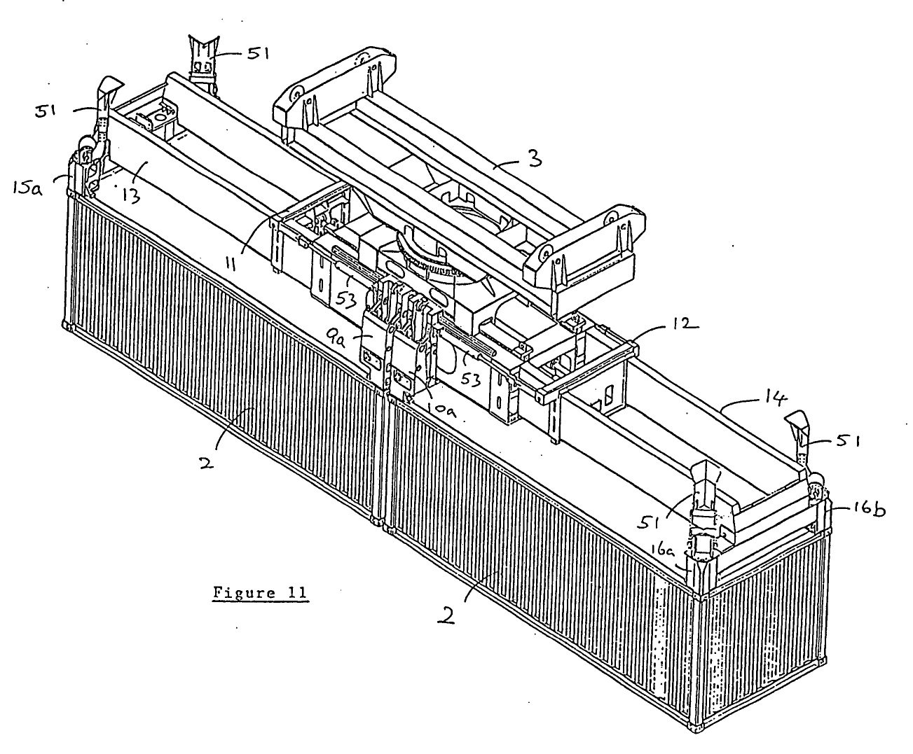

FIG. 10 shows the extension of the second extendable members 13,14 to their fully extended position and with the first extendable members 11,12 extended by the pistons 53 so that the spreader 5 is arranged to pick up a 40 feet container 2a. Similarly, the system 1′ can also be adapted to pickup two 20 feet containers 2, as shown in FIG. 11. The operation of the inner and outer pickup elements 9a,9b,10a,10b,15a,15b,16a,16b to accomplished the task is similar to that of the first embodiment.

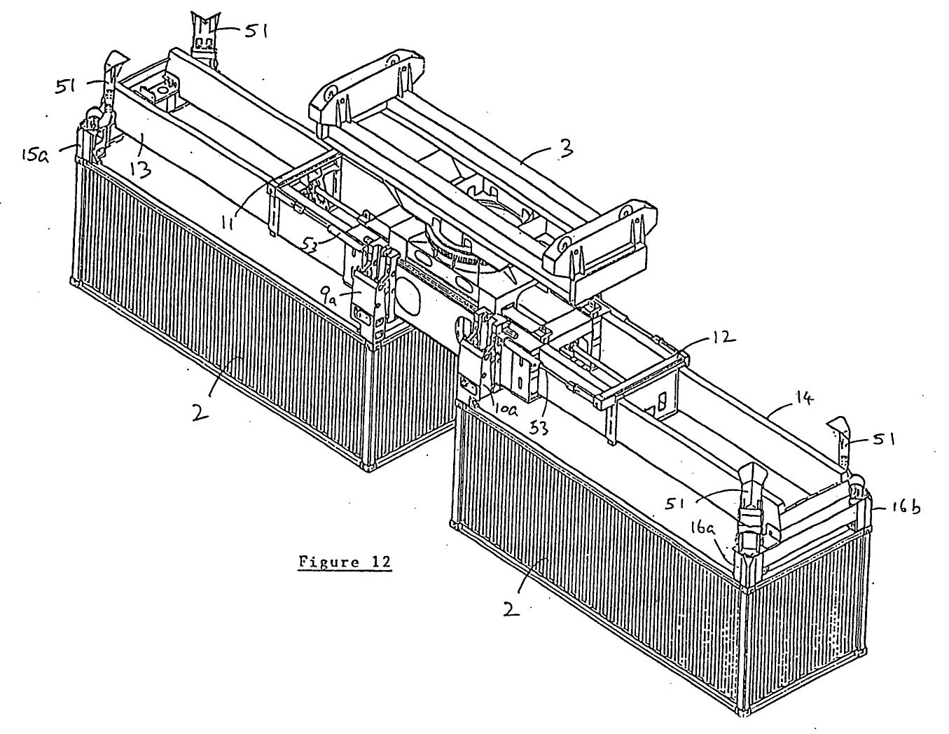

FIG. 12 illustrates the arrangement of FIG. 11 spreading the two 20 feet containers 2 along the containers' longitudinal axes. With the pistons 53 fully extended, further extension of one or both of the first extendable members 11,12 spreads the two containers 2.

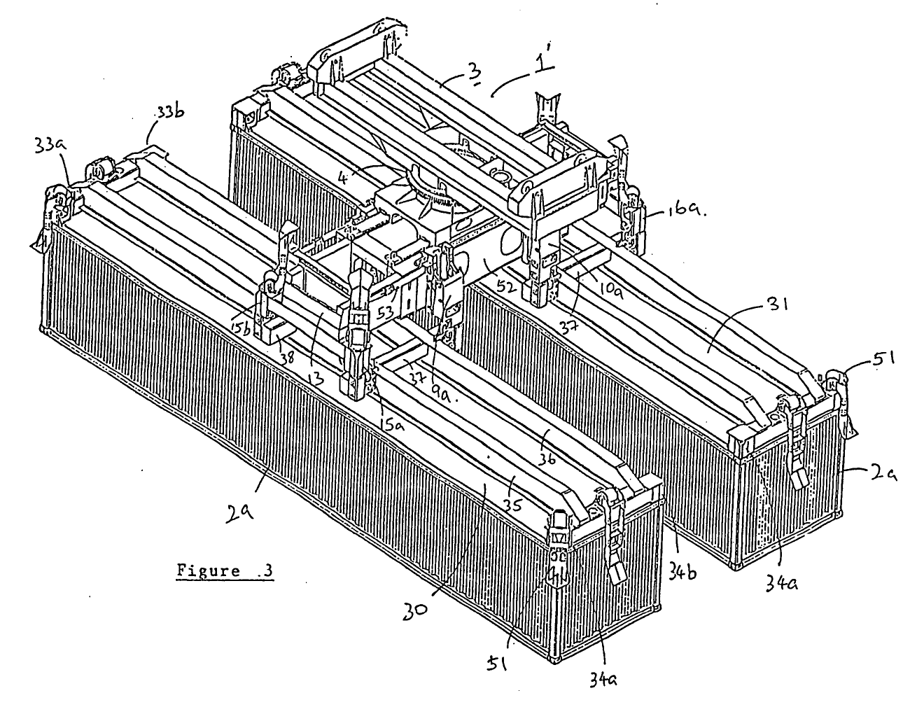

When the system 1′ is adapted to lift two 40 feet or longer containers simultaneously, the spreader 5 is rotated by the rotation device 4 to pickup the extension devices 30,31 similarly to the first embodiment. The distance between the two extension devices 30,31 can be adjusted or spread to correspond to the position of the two 40 feet containers 2a. The locating devices 51, in the “flipped” down position as shown in FIG. 13 (note that in system 1′ some of the locating devices 51 are located not at the corner but near the centre of the end surface of the containers 2a), can be used to locate the corners of the containers 2a so that the pickup elements 33a,33b,34a,34b can engage the apertures of the containers 2a.

During the lifting operation, the retraction or extension of the first extendable member 11,12 and/or the second extendable member 13,14 will reduce or increase the distance respectively between the two containers 2a. However to reduce the gap between the two containers 2a to almost zero, the pistons 53 are retracted which further retracts the first extendable members 11,12 so that effectively, the overall length of the spreader 5 is now approximately 16 feet. Since the width of each 40 feet container 2a is 8 feet, this allows a zero or almost zero gap between the two containers 2a.

This feature has an advantage of saving space since typically when the containers are loaded and stacked into a ship, space is always a consideration. With the ability to achieve a zero gap if required, the system 1′ allows the 40 feet containers 2a to be stacked more closely.

The embodiments described are not to be construed as limitative. For example, even though both embodiments described use the extension devices 30,31 to handle two 40 feet containers 2a simultaneously, containers of other sizes are also envisaged. For example, the extension devices 30,31 may be adapted to twinlift a 35 feet or 45 feet container. The spreader 5 may also be able to lift other relatively smaller containers for example 25 feet containers.

The extension devices 30,31 described in both embodiments are of fixed length. However, the length of the extension devices 30,31 may be adjusted using extendable members in a similar manner to the spreader 5. This allows the flexibility of the extension devices 30,31 to pickup containers of other lengths.

The extension of the piston 53 in the second embodiment is limited to 2 feet in the x and y direction. However, in the event of lifting containers of other sizes or widths, the extendable distance of the piston 53 can be adapted in accordance with the size of the containers so as to achieve a zero gap between the containers.

Having now fully described the invention, it will be apparent to one of ordinary skill in the art that many changes and modifications can be made thereto without departing from the scope of the invention as claimed.

1. A system for handling containers each having a length direction and being of differing lengths in that direction, the system comprising:
a mounting frame;
a spreader having a main axis and supported from the mounting frame; and
two extension devices, each extension device having a longitudinal axis and adapted for connection to a container having a length direction parallel to the longitudinal axis;
the spreader including connection means for releasably connecting the spreader selectively to at least one container with the length direction of the container parallel to the main axis of the spreader, or to the extension devices with the extension devices side-by-side and the main axis of the spreader transverse to the longitudinal axis of both the extension devices.

2. A system according to claim 1 in which connection means includes, in order along the main axis of the spreader, a first pair of pickup elements, a second pair of pickup elements, a third pair of pickup elements and a fourth pair of pickup elements, each pair of pickup elements being arranged on respective sides of the main axis of the spreader, whereby the spreader is selectively and releasably connectable:
(i) to a single container by means of two said pairs of pickup elements,
(ii) to a first container by means of the first and second pairs of pickup elements and to a second container by means of the third and fourth pairs of pickup elements, and
(iii) to a first of the extension devices by means of the first and second pairs of pickup elements and to a second of the extension devices by means of the third and fourth pairs of pickup elements.

3. A system according to claim 2 in which:
the first and fourth pairs of pickup elements are relatively movable along the main axis;
the first and second pairs of pickup elements are relatively movable along the main axis; and
the third and fourth pairs of pickup elements are relatively movable along the main axis;
whereby the spreader is connectable to containers of differing lengths by means of the first and fourth pairs of pickup elements, by means of the first and second pairs of pickup elements, or by means of the third and fourth pairs of pickup elements.

4. A system according to claim 2 in which the first and second pairs of pickup elements are movable together along the main axis relatively to the third and fourth pairs of pickup elements, whereby when the first and second pairs of pickup elements are connected to a first container, and the third and fourth pairs of elements are connected to a second container, the spacing of the first and second containers may be varied.

5. A system according to claim 4 in which the spreader includes two first extendable members movable parallel to the main axis of the spreader between a first position in which the first extendable members are not extended and a second position in which the first extendable members are extended, and two second extendable members, each second extendable member being mounted on a respective one of the first extendable members and movable along the respective first extendable member parallel to the main axis between a first position in which the second extendable member is not extended from the respective first extendable member and a second position in which the second extendable member is extended from the respective first extendable member,
the first pair of pickup elements being connected to a first of the second extendable members, the second pair of pickup elements being connected to the corresponding one of the first extendable members, the third pair of pickup elements being connected to the other of the first extendable members, and the fourth pair of pickup elements being connected to the other of the second extendable members.

6. A system according to claim 5 wherein the second pair of pickup elements is in a fixed position relative the corresponding one of the first extendable members in the direction parallel to the main axis of the spreader, the third pair of pickup elements is in a fixed position relative to the other of the first extendable members in the direction parallel to the main axis of the spreader.

7. A system according to claim 5 wherein the second pair of pickup elements is movable relative to the corresponding one of the first extendable members in the direction parallel to the main axis of the spreader, the third pair of pickup elements is movable relative to the other of the first extendable members in the direction parallel to the main axis of the spreader, whereby the spacing between the first and second pickup elements, and between the third and fourth pickup elements, can be varied independently of the extension of the second extendable members relative to the first extendable members.

8. A system according to any of the preceding claims, further comprising a rotation device attached to the mounting frame and supporting the spreader, the rotation device being operative to rotate the spreader relative to the mounting frame.

9. A system according to claim 8 in which the spreader includes one or more guide rails, and the rotation device is connected to the guide rails slidably thereupon.
